(19) United States
(12) Patent Application Publication
(10) Pub. No.: US 2006/0121796 A1
(43) Pub. Date: Jun. 8, 2006

(54) ELECTRIC PHASE BUS BAR

(75) Inventors: Harry W. Josten, Grapevine, TX (US); Jason P. Wiant, Bedford, TX (US)

Correspondence Address: FOLEY & LARDNER LLP, 777 EAST WISCONSIN AVENUE, SUITE 3800, MILWAUKEE, WI, 53202-5308, US

(73) Assignee: Siemens Corporation

(21) Appl. No.: 11/007,664

(22) Filed: Dec. 8, 2004

(51) Int. Cl. H01R 9/22

(52) U.S. Cl. 439/715

(57) ABSTRACT

A method and an electric bus bar in an electrical enclosure. The electrical bus bar includes a web portion having a first side and a second side. A pair of flanges are formed with one flange on each side of the web portion and positioned perpendicular to the web portion. The sum of the lengths of both flanges is less than the width of the web portion.

### FIELD

The present invention relates generally to the field of electrical switchboards and panel boards and more particularly to an electric bus bar in switchboard and panel board enclosures, where the sum of the length of the bus bar flanges is less than the width of the bus bar web portion.

### BACKGROUND

Switchgear assemblies and switchboards and panel boards are general terms which cover metal enclosures, housing switching and interrupting devices such as fuses and circuit breakers, along with associated control, instrumentation and metering devices. Such assemblies typically include associated bus bars, interconnections and supporting structures used for the distribution of electrical power. Low voltage switchgear and switchboards operate at voltages of up to 600 volts and with continuous currents up to 5000 amps or higher. Such devices are also designed to withstand short circuit currents ranging up to 200,000 amps (3 phase RMS symmetrical).

Typical switchgear equipment is composed of a lineup of several metal and closed sections. Each section may have several circuit breakers stacked one above the other vertically in the front of the section with each breaker being enclosed in its own metal compartment. Each section has a vertical or section bus which supplies current to the breakers within the section by short horizontal branch busses, also referred to as run-in busses. The vertical bus bars in each section are supplied with current by a horizontal main bus bar that runs through the lineup of metal enclosed sections. A typical arrangement includes bus bars for each electrical phase of a multi-phase system which may include three power phases and a neutral.

In multi-phase systems flat bus bars require significant bracing to have them withstand short circuit currents mentioned above. Other types of bus bars used in switchgear enclosures include I-beam type bus bars that may be U-shaped or enclosed C-shaped, return flanges on the ends of the main flanges creating five surfaces. Such known bus bars require connections on the flat surfaces of the flanges because of the contoured web portions or they contain considerably more material. The U-shaped bus channel typically has a curved section that is not suitable for bolting connections within the switchgear enclosure.

Thus there is a need for an electric bus bar that provides better thermal performance than either flat bars or other types of channel bus designs. There is a further need for an electric bus bar that can be fabricated while the bar is in a flat condition and manipulated to form channels. There is a further need for electric bus bar that can be nested with other electric bus bars to increase the current continuous current reading for equipment in the enclosure. There is a further need for an electric bus bar that improves convective cooling of the bus bar, increases the section modulus for high short circuit-capability and further provides a uniform current distribution throughout cross section (skin effect) of the bus bar.

### SUMMARY OF THE INVENTION

There is provided an electric bus bar in an electrical enclosure. The electrical bus bar includes a web portion having a first side and a second side. A pair of flanges are formed with one flange on each side of the web portion and positioned perpendicular to the web portion, with the flanges of each bus bar aligned opposite each other, and wherein the three outside surfaces of the flanges and web portion are planar. The sum of the lengths of both flanges is less than the width of the web portion. On one embodiment, the thickness of the web portion in both flanges is equal. In another embodiment, the bus bar includes a second electric bus bar having a web portion and a pair of flanges with each flange formed on one side of the web portion and positioned perpendicular to the web portion wherein the sum of the lengths of both flanges is less than the width of the web portion with the flanges of each bus bar aligned opposite each other a spaced apart distance to form a rectangular tube. Another embodiment includes two additional C-shaped bus bars configured to nest between the flanges of the first and second bus bars. Another embodiment of the electric bus bar provides the flanges are orientated in a vertical aspect relative to the electrical equipment enclosure as a vertical bus bar. A further embodiment of the electric bus bar provides the flanges orientated in a horizontal aspect relative to the electrical equipment enclosure as a horizontal bus bar.

There is also provided an electric bus bar system in an electrical enclosure. The electric bus bar system comprises a first bus bar member and a second bus bar member. Each bus bar member has a web portion with a first side and a second side and a pair of flanges. For each bus bar member, one flange is formed on each side of the web portion and positioned perpendicular to the web portion. The sum of the lengths of both flanges for a given bus bar member is less than the width of that bus bar member's web portion. The flanges of each bus bar are aligned opposite each other a spaced apart distance to form a rectangular tube. In another embodiment, a third bus bar member and a fourth bus bar member, are provided with the third bus bar member nested between the flanges of the first bus bar member and the fourth bus bar member nested between the flanges of the second bus bar member.

There is additionally provided a method for making an electric bus bar having planar outside surfaces and a C-shaped cross section for an electric equipment enclosure. The method comprises the steps of providing a planar rectangular cross section bar of suitable material. Fabricating orifices of preselected locations along the length of the bar. Manipulating a portion of the bar to form a first flange perpendicular to the bar. Manipulating another portion of the bar to form a second flange perpendicular to the bar and in a parallel plane with the first flange. A portion of the bar between the flanges define a web, wherein the sum of the lengths of both flanges is less than the length of the web, with the flanges of the bus bar aligned opposite each other. Another embodiment of the web includes the steps of providing a second planar, rectangular cross section bar. The fabricating orifices at selected locations on the second bar corresponding to the orifices in the other bar. Repeating the manipulation steps of the first bar on the second bar. Positioning the first bar and second bar with the flanges of each bus bar aligned opposite each other a spaced apart distance to form a rectangular tube. Another embodiment of the method includes the step of orientating the flanges in a vertical aspect relative to the electrical equipment enclosure as a vertical bus bar. A further embodiment of the method includes the step of orientating the flanges in a horizontal aspect relative to the electrical equipment enclosure as a horizontal bus bar.

There is provided an electric bus bar in an electrical enclosure. The electrical bus bar includes a web portion having a first side and a second side. A pair of flanges are formed with one flange on each side of the web portion and positioned perpendicular to the web portion and define a C-shaped cross section. The sum of the lengths of both flanges is less than the width of the web portion. On one embodiment, the thickness of the web portion in both flanges is equal. In another embodiment, the bus bar includes a second electric bus bar having a web portion and a pair of flanges with each flange formed on one side of the web portion and positioned perpendicular to the web portion wherein the sum of the lengths of both flanges is less than the width of the web portion with the flanges of each bus bar aligned opposite each other a spaced apart distance to form a rectangular tube. Another embodiment includes two additional C-shaped bus bars configured to nest between the flanges of the first and second bus bars. Another embodiment of the electric bus bar provides the flanges are orientated in a vertical aspect relative to the electrical equipment enclosure as a vertical bus bar. A further embodiment of the electric bus bar provides the flanges are orientated in a horizontal aspect relative to the electrical equipment enclosure as a horizontal bus bar.

### BRIEF DESCRIPTION OF THE DRAWINGS

FIG. 1 is a perspective view of a switchgear enclosure including compartments for electrical equipment, such as circuit breakers and including exemplary embodiments of an electrical bus bar system with at least one electrical bus bar orientated as a vertical bus bar, and another electric bus bar orientated as a horizontal bus bar.

FIG. 2 is a perspective view of a switchgear enclosure (without some of the side panels and structural members of the enclosure for clarity) including electric bus bar system having electric bus bars orientated as horizontal bus bars and vertical bus bars coupled to each other as well as to runback bus bars and run in bus bars mounted on mounting bases.

FIG. 3 is a perspective view of a rear aspect of the electrical enclosure illustrated in FIG. 2.

FIG. 4 is a side view of a partial electrical enclosure illustrating circuit breakers coupled to an exemplary embodiment of an electrical bus system.

FIG. 5 is a perspective view with detailed cross section of an exemplary embodiment of electrical bus bars for a three phase system.

FIG. 6A is a cross section of an exemplary embodiment of an electric bus bar.

FIG. 6B is a cross section of a first and second electric bus bar with the flanges of each bus bar aligned opposite each other in parallel planes and in a spaced apart distance to form a rectangular tube.

FIG. 6C is a cross section of an exemplary embodiment of an electric bus bar with the flanges of each bus bar aligned opposite each other a spaced apart distance to form a rectangular tube and with nested bus bars on each side of the tube.

### DETAILED DESCRIPTION OF EXEMPLARY EMBODIMENTS

Before describing the exemplary embodiments of an electrical bus bar system for electrical equipment in a switchgear enclosure, several comments are appropriate. Switchgear assemblies and panel board assemblies typically include vertical (section) bus bars to distribute electrical power within the enclosures. In a short circuit condition, extreme magnetic forces are created in the bus bars as a result of short circuit currents up to and including 200,000 amps symmetrical RMS flowing through each bus bar. In a three phase power system (typically) a short circuit current flows through such bus bars with magnetic forces between adjacent bus bars tending to move such bus bars laterally (perpendicular) to the current flow. Such movement of the bus bars are typically prohibited or inhibited to avoid damage in arcing with switchgear enclosures by bus bar brace apparatus and equipment arrangements within the switchgear cabinet.

In order to improve the section modulus for high short circuit capability, a C-shaped bus bar can be used. The C-shaped bus bar is stronger than either a flat bar typically used in conventional electrical equipment enclosures and provide better current distribution through a uniform cross section. An additional advantage to the C-shaped electric bus bar is the uninhibited flow of air through the C-shaped channel thereby improving the cooling effects of the bus bar by convection air currents. This latter characteristic is referred to as a “chimney effect.” Also, if two C-shaped channel bus bars are aligned with their short sidewalls of each C-shaped bus bar facing each other a spaced apart rectangular tube is formed which further facilitates air movement and does cooling of the bus bar system.

Another advantage of the C-shaped electric bus bar is that fabrication of mounting orifices in the bus bar can be accomplished when the bus bar is in its flat state. The orifices can be punched or drilled to accommodate mounting bolts or screws or other equipment attachment apparatus. After the selected orifices are formed in the flat bus bar, the bus bar can be manipulated to form the flanges by either a roll forming method or a bending in a press brake or other suitable machine. It should be understood that the orifices can also be formed and created in the web portion after forming the channel. However, the preferred method is manipulating a flat bar. The planar outside surfaces of the flanges and web portion of the bus bar facilitates coupling of additional bus bars and associated electrical equipment.

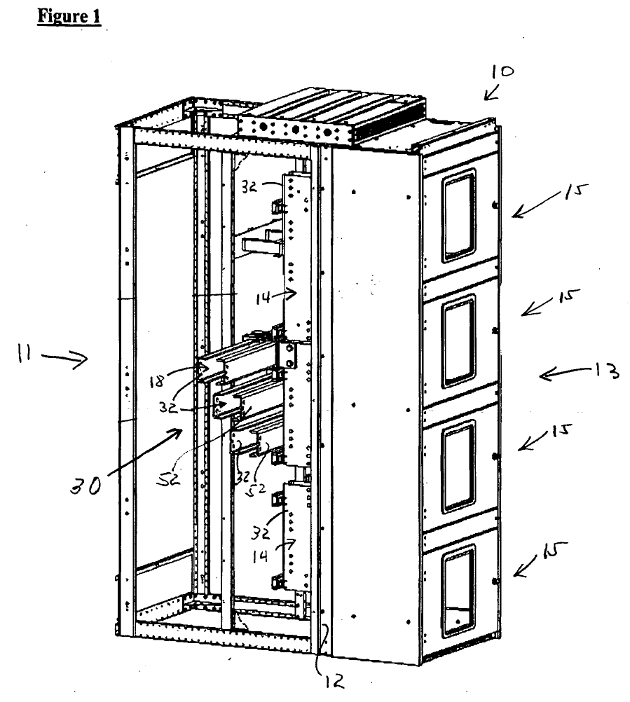

Referring now to the figures, FIG. 1 is an illustration of an exemplary embodiment of a switchgear enclosure 10 without several of the outer panels for clarity purposes. FIG. 1 also illustrates electrical equipment compartments which can house electrical equipment such as circuit breakers or switches. A mounting base 22, (not shown in FIG. 1) forms the rear wall of the equipment compartment 15 and is coupled to several of the frame members 12 of the switchgear enclosure 10.

FIG. 1 specifically depicts a multi-phase switchgear assembly conventionally having three power phases, A, B and C. A neutral bus or grounding bus can also be provided. In the illustration of FIG. 1, horizontal bus bars 18 feed the main electric power to enclosure 10 and to adjacent enclosures (not shown) in a typical installation. FIG. 1 also illustrates vertical bus bars 14 which are coupled to the horizontal bus bars 18 and to runback bus bars 19 which extend into the electric equipment compartments.

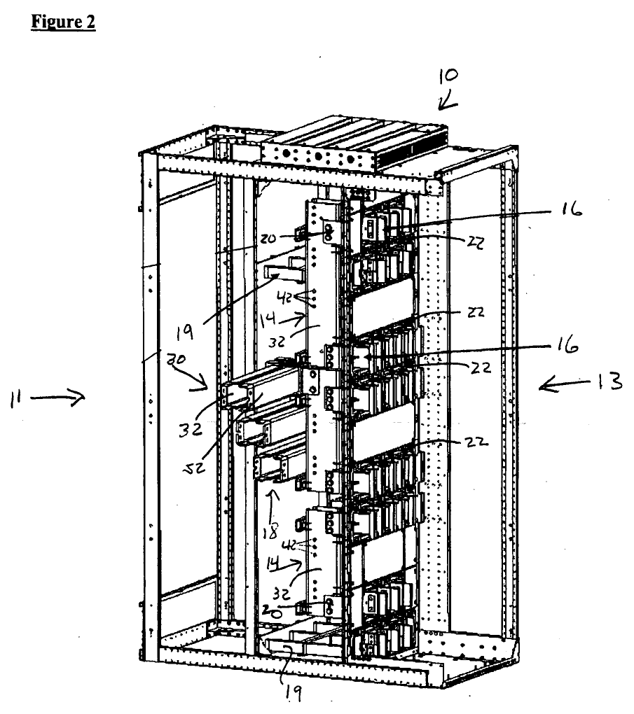

FIG. 2 illustrates an electric bus bar system 30 which includes horizontal bus bars 18 and vertical bus bars 14 coupled to runback bus bars 19 and run-in bus bars 20, the latter which are coupled to the mounting base 22.

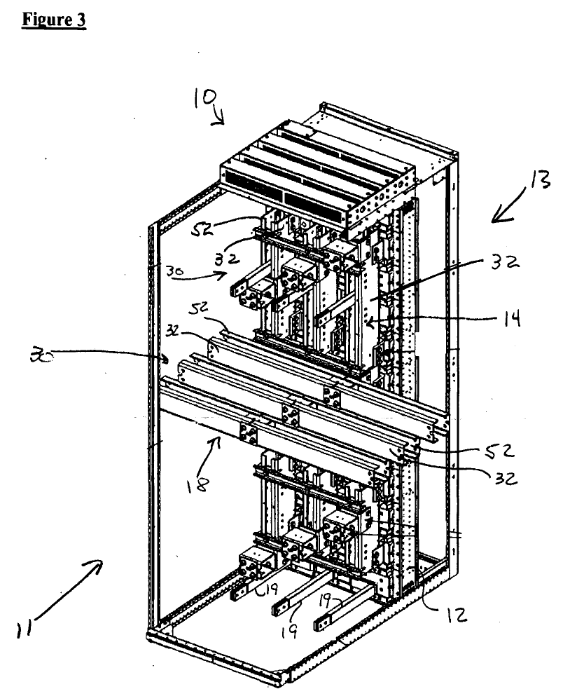

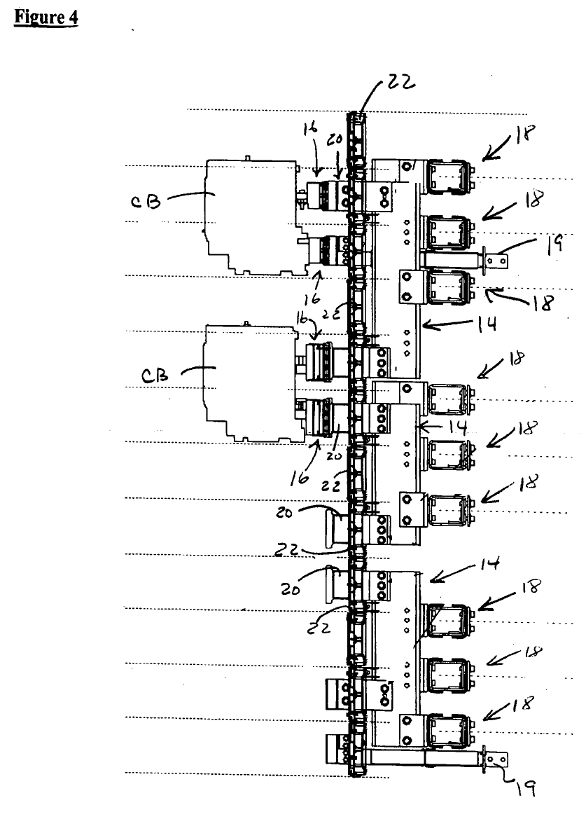

FIG. 3 illustrates vertical bus bars 14 extending typically throughout the height of the switchgear in enclosure 10 with horizontal bus bars 18 selectively positioned and connected mechanically and electrically through the vertical bus bars 14 for distribution of power within the system. Spaced apart frame members 12 are mounted within the switchgear enclosure 10 a predetermined position to support electrical equipment such as circuit breakers mounted in the enclosure 10. The equipment can be accessed from either the front side 13 or the back side 11 of the enclosure 10. A typical electrical equipment that is mounted in a switchgear enclosure 10 is a circuit breaker CB (see FIG. 4). The circuit breaker mechanism is typically contained within a housing. The housing is coupled to a mounting base 22 which supports the circuit breaker housing and provides an apparatus for coupling the circuit breaker to the various bus bars within the switchgear enclosure 10. A mounting plate system is used to attach the mounting member 22 to the frame member 12 of the switchgear enclosure 10.

FIG. 4 illustrates exemplary embodiment of an electrical bus bar system 30 having a plurality of electric bus bars some orientated as a vertical bus bar 14 and some orientated as a horizontal bus bar 18.

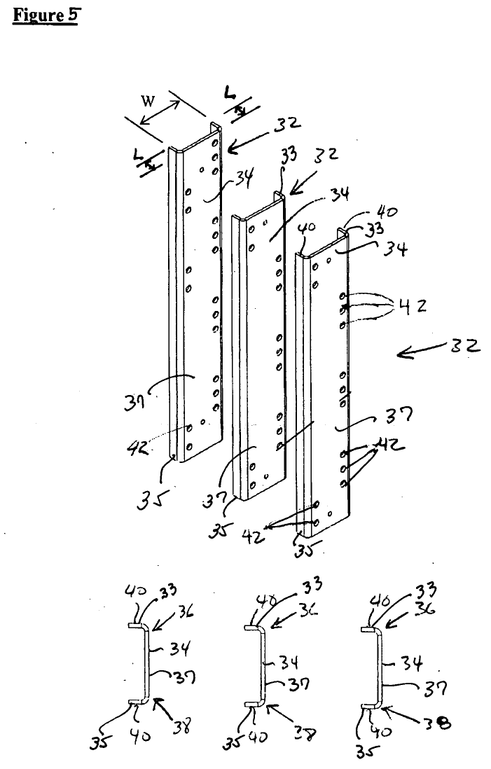

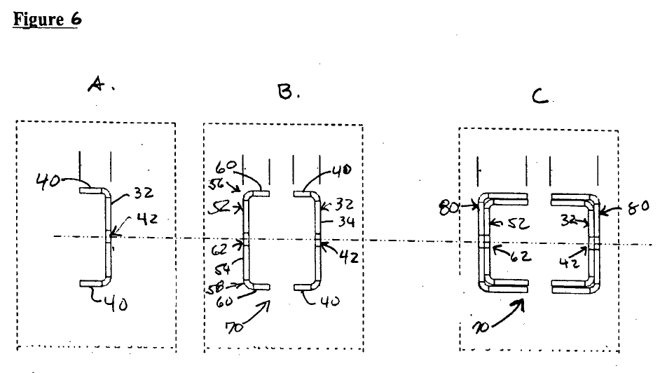

FIGS. 5 and 6 will be utilized for describing an exemplary embodiment of an electric bus bar system 30 and it should be understood that the bus bars described can be orientated either as a horizontal or a vertical bus bar.

Referring to FIG. 5, an electric bus bar 32 includes a web portion 34 having a first side 36 and a second side 38. A pair of flanges 40 are included. One flange is formed on each side 36, 38 of the web portion 34 and positioned perpendicular to the web portion 34, wherein the sum of the lengths L of both flanges 40 is less than the width W of the web portion 34 (L+L<W) and define a C-shaped cross section. In FIG. 5, a single electric bus bar for each phase of an electrical system is illustrated. Orifices 42 are defined in the web portion 34 of each electric bus bar 32. The thickness of the web portion 34 and both flanges 40 are equal, however, it should be understood that the lengths of the flanges and the length of the web portion 34, as viewed in cross section, can be any suitable distance as determined by the designer of the electric bus bar provided the above described relationship is maintained. The outside surface 33, 35 of the flanges 40 and the outside surface 37 of the web portion are substantially planar. That is to say, the outside surfaces 33, 35, 37 are flat within tolerances of the process which manufactured the bus bar 32.

Although the flanges 40 can be coupled to the web portion 34 by fasteners or a welding process, a single integral, one-piece electric bus bar is preferred. The bus bar, including the web portion 34 and both flanges 40 can be composed of a material selected from either copper or aluminum.

Another embodiment of the electrical bus bar system 30 includes a second electric bus bar 52 having a web portion 54 with a first side 56 and a second side 58. A pair of flanges 60, with one flange 60 formed on each side of the web portion 54. The flanges are positioned perpendicular to the web portion 54 with the sum of the lengths of both flanges 60 being less than the length of the width of the web portion 54. The flanges 40, 60 of each bus bar 32, 52 are aligned opposite each other a spaced apart distance to form a rectangular tube 70. The rectangular tube 70 forms an electric bus bar for a single phase in the electrical distribution system. (See FIGS. 2 and 3 and 6B.)

The electric bus bar 32 or the combination of bus bar 32 and 52 can be orientated so that the flanges 40 of electric bus bar 32 and the flanges 60 of the electric bus bar 52 are orientated in a vertical aspect relative to the electrical equipment enclosure as a vertical bus bar 14. (See FIGS. 3 and 5.) An electric bus bar can also be positioned so that the flanges 40 of electric bus bar 32 and the flanges 60 of electric second bus bar 52 is orientated in a horizontal aspect relative to the electric equipment enclosure 10 as a horizontal bus bar 18. (See FIGS. 1 and 3.)

Another embodiment of the electrical bus bar system 30 includes at least two additional C-shaped bus bars 80 configured to nest between the flanges 40, 60 of the first and second bus bars 32, 52 as illustrated in FIG. 6C. Such configuration increases the current carrying capacity of a given bus bar in a multi-phase system. Each of the additional C-shaped bus bars 80 are configured and formed as the first electric bus bar 32 and the second electric bus bar 52.

It should be understood that additional braces in either a two phase or three phase system may be required to brace a given set of bus bars in an electric bus bar system 30 to withstand anticipated short circuit current conditions. Such additional bracing typically is formed to receive the bus bars of the electric bus bar system 30 and are typically composed of insulating thermoplastic or thermoset material.

An exemplary embodiment of a method for making an electric bus bar 32 having a C-shaped cross section for an electric equipment enclosure 10 is described below. A planar, rectangular cross section bar of copper or aluminum is fabricated with orifices 42 at selected locations along the length of the bar. Such fabrication can be accomplished by drilling, punching or other fabricating methods, such as laser cutting or water drill. Such orifices 42 are easier to form in the planar bar before additional manipulation of the bar is performed. The orifices are configured to receive fasteners to couple bus bars together and to mount various electrical equipment.

After the orifices 42 are fabricated in the bar, a portion of the bar is manipulated to form a first flange 40 perpendicular to the bar on the first side 36 of the electric bus bar 32. Another portion of the bar 32 is manipulated to form a second flange 40 perpendicular to the bar and in a parallel plane with the first flange 40 on the second side 38 of the electric bus bar 32. Both flanges 40 are facing each other as illustrated in FIG. 5. The portion of the bar between the flanges 40 define a web 34 wherein the sum of the lengths L of both flanges 40 is less than the width W of the web portion 34. A typical manufacturing manipulation of the bar is to use a press brake to create the flanges. Another method of manufacturing can be a rolling process or an extrusion process however the press brake method is the preferred method of fabrication.

As mentioned above, the web 34 and the flanges 40 are composed of material selected from a group including copper and aluminum and the thickness of the web 34 and the flanges 40 are equal providing substantially uniform cross section within acceptable tolerances.

Another embodiment of the method includes the steps of providing a second planar, rectangular cross section bar 52 and fabricating orifices 62 at selected locations corresponding to the orifices 42 and the other bar 32. The method includes repeating of the manipulation steps on the second bar that were performed on the first bar 32. Positioning the first bar 32 and the second bar 52 with the flanges 40, 60 of each bar aligned opposite each other a spaced apart distance to form a rectangular tube 70. (See FIGS. 6B, 6C, 2 and 3.) As discussed above, the bus,bars of the electric bus bar system 30 can be orientated as either a vertical bus bar 14 or a horizontal bus bar 18. Further, at least two additional C-shaped bus bars can be provided. The two additional C-shaped bus bars can be nested between the flanges of the first and second bars as illustrated in FIG. 6C. Such configuration allows for a higher constant current carrying capability of the bus bar in either the vertical or horizontal position.

The orifices 42, 62 defined in the web portions 34, 54 of each of the electric bus bars 32, 52 facilitate the coupling of horizontal bars 18 and run-in bus bars 20 when assembling the electric bus bar system 30 for the electrical enclosure 10. The primary disconnects 16 of circuit breakers CB are coupled to the run-in bus bars 20 and used to establish the electrical and mechanical connections within an electrical system of the electrical enclosure 10.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components or the two components and any additional member being attached to one another. Such joining may be permanent in nature or alternatively may be removable or releasable in nature

Thus, there is provided an electrical bus bar system for use in a switchgear enclosure. The foregoing description of embodiments have been presented for purposes of illustration and description. It is not intended to be exhaustive nor to be limited to the precise forms disclosed and modifications and variations are possible in light of the above teachings or may be acquired by practice of the invention. The embodiments are chosen and described in order to explain the principles and practical application to enable one skilled in the art to utilize the modular insulation system and various embodiments and with various modifications that are suited to the particular use contemplated. It is intended that the scope of the C-shaped electric bus bar system be defined by the claims appended hereto and their equivalents.

1. An electric phase bus bar in an electrical enclosure, the electric phase bus bar comprising:
a web portion having a first side and a second side; and
a pair of flanges, with one flange formed on each side of the web portion and positioned perpendicular to the web portion, wherein the sum of the lengths of both flanges is less than the width of the web portion, with the flanges of each bus bar aligned opposite each other and wherein the three outside surfaces of the flanges and web portion are planar.

2. The electric phase bus bar of claim 1, wherein the thickness of the web portion and both flanges is equal.

3. The electric phase bus bar of claim 1, wherein the web portion and both flanges are integral and one piece.

4. The electric phase bus bar of claim 1, wherein the web portion and both flanges are composed of a material selected from one of copper and aluminum.

5. The electric phase bus bar of claim 1, further comprising a second electric phase bus bar having a web portion having a first side and a second side; and a pair of flanges, with one flange formed on each side of the web portion and positioned perpendicular to the web portion, wherein the sum of the lengths of both flanges is less than the width of the web portion, with the flanges of each bus bar aligned opposite each other a spaced apart distance to form a rectangular tube.

6. The electric phase bus bar of claim 1, wherein the flanges are orientated in a vertical aspect relative to the electrical equipment enclosure as a vertical bus bar.

7. The electric phase bus bar of claim 1, wherein the flanges are orientated in a horizontal aspect relative to the electrical equipment enclosure as a horizontal bus bar.

8. The electric phase bus bar of claim 5, including at least two additional C-shaped bus bars configured to nest between the flanges of the first and second bus bars.

9. A electric phase bus bar system in an electrical enclosure, the electric phase bus bar system comprising:
a first bus bar member; and
a second bus bar member, with each bus bar having a web portion having a first side and a second side; and a pair of flanges, with one flange formed on each side of the web portion and positioned perpendicular to the web portion, with the flanges of each bus bar aligned opposite each other, wherein the sum of the lengths of both flanges is less than the width of the web portion, with the flanges of each bus bar aligned opposite each other a spaced apart distance forming a rectangular tube.

10. The electric phase bus bar system of claim 9, a third bus bar member and a fourth bus bar member, with the third bus bar member nested between the flanges of the first bus bar member and the fourth bus bar member nested between the flanges of the second bus bar member.

11. The electric phase bus bar system of claim 9, wherein the thickness of the web portion and both flanges, of each bus bar member, is equal.

12. The electric phase bus bar system of claim 9, wherein the web portion and both flanges, of both bus bar members, are integral and one piece.

13. The electric phase bus bar system of claim 9, wherein the web portion and both flanges, of each bus bar member is composed of a material selected from one of copper and aluminum.

14. The electrical phase bus bar system of claim 9, wherein the flanges are orientated in a vertical aspect relative to the electrical equipment enclosure as a vertical bus bar.

15. The electric phase bus bar system of claim 9 wherein the flanges are orientated in a horizontal aspect relative to the electrical equipment enclosure as a horizontal bus bar.

16. A method for making an electric phase bus bar for an electrical equipment enclosure, the method comprising the steps of:
providing a planar, rectangular cross-section bar;
fabricating orifices at selected locations along the length of the bar;
manipulating a portion of the bar to form a first flange perpendicular to the bar; and
manipulating another portion of the bar to form a second flange perpendicular to the bar and in a parallel plane with the first flange, with the portion of the bar between the flanges defining a web,
wherein the sum of the lengths of both flanges is less that the width of the web, with the flanges of each bus bar aligned opposite each other.

17. The method of claim 16, wherein the thickness of the web and both flanges is equal and configured with a C-shaped cross section.

18. The method of claim 16, wherein the web and both flanges are composed of material selected from group including copper and aluminum.

19. The method of claim 16, including the steps of:
providing a second planar, rectangular cross-section bar;
fabrication orifices at selected locations corresponding to the orifices in the other bar;
repeating the manipulation steps on the second bar; and positioning the first bar and second bar with the flanges of each bus bar aligned opposite each other a spaced apart distance to form a rectangular tube.

20. The method of claim 16, including the step of orientating the flanges in a vertical aspect relative to the electrical equipment enclosure as a vertical phase bus bar.

21. The method of claim 16, including the step of orientating the flanges in a horizontal aspect relative to the electrical equipment enclosure as a horizontal phase bus bar.

22. The method of claim 18, including the step of providing at least two additional C-shaped bus bars and nesting each of the additional C-shaped bus bars between the flanges of the first and second bars.

23. An electric phase bus bar in an electrical enclosure, the electric phase bus bar comprising:
a web portion having a first side and a second side; and
a pair of flanges, with one flange formed on each side of the web portion and positioned perpendicular to the web portion, wherein the sum of the lengths of both flanges is less than the width of the web portion and define a C-shaped cross-section.

24. The electric phase bus bar of claim 23, wherein the thickness of the web portion and both flanges is equal.

25. The electric phase bus bar of claim 23, wherein the web portion and both flanges are integral and one piece.

26. The electric phase bus bar of claim 23, wherein the web portion and both flanges are composed of a material selected from one of copper and aluminum.

27. The electric phase bus bar of claim 23, further comprising a second electric bus bar having a web portion having a first side and a second side; and a pair of flanges, with one flange formed on each side of the web portion and positioned perpendicular to the web portion, wherein the sum of the lengths of both flanges is less than the width of the web portion, with the flanges of each bus bar aligned opposite each other a spaced apart distance to form a rectangular tube.

28. The electric phase bus bar of claim 23, wherein the flanges are orientated in a vertical aspect relative to the electrical equipment enclosure as a vertical phase bus bar.

29. The electric phase bus bar of claim 23, wherein the flanges are orientated in a horizontal aspect relative to the electrical equipment enclosure as a horizontal phase bus bar.

30. The electric phase bus bar of claim 27, including at least two additional C-shaped bus bars configured to nest between the flanges of the first and second bus bars.
